(19) United States
(12) Patent Application Publication
(10) Pub. No.: US 2009/0182788 A1
(43) Pub. Date: Jul. 16, 2009

(54) APPARATUS AND METHOD FOR CUSTOMIZED EMAIL AND DATA MANAGEMENT

(75) Inventors: Alan Chung, San Francisco, CA (US); Peter Stern, New York, NY (US); Tom Alison, Hoboken, CA (US); Robert Kieffer, Bend, OR (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Zenbe, Inc.

(21) Appl. No.: 12/353,740

(22) Filed: Jan. 14, 2009

Related U.S. Application Data
(60) Provisional application No. 61/020,780, filed on Jan. 14, 2008.

(51) Int. Cl. G06F 15/16; G06F 17/30

(52) U.S. Cl. 707/204; 709/206; 707/E17.005

(57) ABSTRACT

An apparatus and method for customized email and data management is disclosed. According to one embodiment, a collaborative page is created to contain an email module configured to access one or more email accounts. Emails from the one or more email accounts are selected using an email selection criterion. The selected emails are processed to parse data based on a parsing rule. The emails and the parsed data are displayed on the collaborative page. The collaborative page is updated with new emails and the updated content.

The present application claims the benefit of and priority to U.S. Provisional Patent Application No. 61/020,780 filed on Jan. 14, 2008, and is hereby incorporated by reference.

### FIELD

The field of the invention relates generally to computer systems and more particularly relates to an apparatus and method for email and data management.

### BACKGROUND

As Internet technology evolves, more people use emails and email users receive more emails than ever. Email users spend more time to keep up with emails, which otherwise can be spent for productive tasks. The tools available today to users for handling emails have been largely unchanged for a decade or more, and they are inadequate for handling the volume of emails received by users.

Email users exchange emails for leading a project, organizing an event, coordinating efforts among other users. These activities often require collaborative efforts to work together as a team. Emails, text messaging, phone calls, or any combination of these communication methods may not be adequate for leading a project or organizing an event with other collaborators because they require additional administrative tasks, and in most cases, are difficult to keep track of the status of the project or the event on a common place.

### SUMMARY

An apparatus and method for customized email and data management is disclosed. According to one embodiment, a collaborative page is created to contain an email module configured to access one or more email accounts. Emails from the one or more email accounts are selected using an email selection criterion. The selected emails are processed to parse data based on a parsing rule. The emails and the parsed data are displayed on the collaborative page. The collaborative page is updated with new emails and the updated content.

The above and other preferred features, including various novel details of implementation and combination of elements will now be more particularly described with reference to the accompanying drawings and pointed out in the claims. It will be understood that the particular methods and apparatus are shown by way of illustration only and not as limitations. As will be understood by those skilled in the art, the principles and features explained herein may be employed in various and numerous embodiments.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates an exemplary page for customized email and data management, according to one embodiment;

FIG. 2 illustrates an exemplary process for archiving a page, according to one embodiment;

FIG. 3 illustrates an exemplary process for configuring a page, according to one embodiment;

FIG. 4 illustrates an exemplary process for parsing email data, according to one embodiment;

FIG. 5 illustrates an exemplary process for shared email collaboration on a page, according to one embodiment;

FIG. 6 illustrates an exemplary process for sharing a page with a collaborator, according to one embodiment; and

FIG. 7 illustrates an exemplary process for setting up an email account linked to a page, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

An apparatus and method for customized email and data management is disclosed. According to one embodiment, a collaborative page is created to contain an email module configured to access one or more email accounts. Emails from the one or more email accounts are selected using an email selection criterion. The selected emails are processed to parse data based on a parsing rule. The emails and the parsed data are displayed on the collaborative page. The collaborative page is updated with new emails and the updated content.

In the following description, for the purposes of explanation, specific nomenclature is set forth to facilitate an understanding of the various inventive concepts disclosed herein. However, it will be apparent to one skilled in the art that these specific details are not required in order to practice the various inventive concepts disclosed herein.

The present system and method also relates to apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of device including flash memory devices, floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus.

The methods presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

According to one embodiment, the present system and method allows a user to, easily and in many cases automatically, organize their emails by topic or project. The users groups emails on a page and links them with other information such as calendar, task list, chat/IM, files, notes, URL links using a template. The user has a project-centric view of the topic or project integrated with emails and other relevant information. It greatly reduces the time to manage emails, because the user is able to focus on the topic or project with the relevant information at their finger tips. According to one embodiment, the present system allows users to share the page and collaborate with other users to update and manage the page. Users' email inboxes are no longer one way collection of messages. Users are allowed to select and retrieve email messages and other information to share with others.

The present system and method may be used in various embodiments and applications. In order to illustrate the usage and benefits of the present system and method, the following use cases are disclosed. However, it is appreciated that the present system and method may be applied in a variety of ways and conditions, and the following exemplary use cases are not understood to limit the scope of the present subject matter.

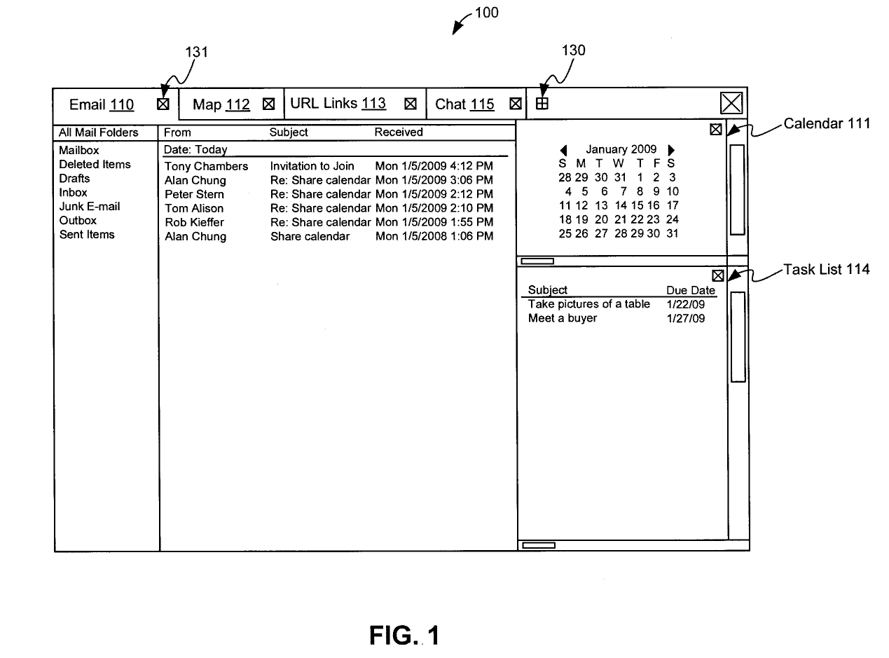

FIG. 1 illustrates an exemplary page for customized email and data management, according to one embodiment. In one embodiment, user 101 posts an advertisement to sell a table on an Internet site (e.g., craigslist) by creating a new page 100 for the sale. For example, user 101 creates the page from a template to include a calendar module 111 and a chat module 115. Users 101 may group emails with other information using the template and provide content to the modules contained in the template. The content to the modules may be automatically generated or parsed from other content, for example emails 110 or URL links 113. Modules 110, 112, 113, and 115 are user extendable, and user 101 can add or remove additional modules by clicking on button 130 or 131.

Calendar module 111 shows the events linked to the page. For example, user 101 may plan a photo-shoot on a certain date and mark the event on the calendar. An appointment with a prospective buyer may appear on the calendar as well. Chat module 115 may be used to communicate real-time with other users who has an access to the page. User 101 may upload photographs of the table to the page 100 and write text in a note on page 100.

User 101 makes the posting to an Internet site, for example craigslist, and specifies that all emails from craigslist be redirected to page the 100 without cluttering user 101's inbox. As email responses to the advertisement flood in, user 101 uses calendar 111 to track the appointments to show the table for sale. User 101 may share the page 100 with a collaborator 102 so that the collaborator 102 can help with some of the appointments or other administrative tasks. User 101 and collaborator 102 may access the page 100 over a network, for example the Internet. Collaborator 102 may represent a spouse, friend, family, or any other user 101 who are appointed to share the page 100. User 101 and collaborator 102 may use the chat module 115 on the page 100 to arrange the time and role for the appointments. Using the present system and method, user 101 would not have to hand forward emails from an interested buyer to collaborator 102 because user 101 and collaborator 102 communicate via the page 100 without leaving extraneous trails of communication with emails, instant messaging, text messaging, or phone calls. By sharing the page 100, user 101 and collaborator 102 eliminate a great deal of email traffic, and the record-keeping becomes much more convenient and systematic. After the table is sold, user 101 archives the page 100 for future record.

According to another embodiment, user 101 creates a page for a house hunting project. Similar to the above example, user 101 uses the page 100 to collect the emails from various realtors. User 101 may utilize calendar 111 to keep track of open house hours. Map module 112 plots the houses that user 101 and collaborator 112 are interested in. URL link module 113 keeps track of the properties on realtor's Websites and other useful information. Task list 114 maintains and tracks actions such as getting loan approval and getting insurance quotes. Photos from various open house tours are uploaded to the page 100 for viewing at a convenient time. Depending on the purpose and usage of pages, templates with a different set of modules are offered to help user 101 to create an appropriate page.

User 101 may share the page 100 with one or more collaborators 102. Collaborators 102 may look to purchase a house in a similar neighborhood at the same time or help user 101 to build and manage a collective database for the house hunting project. Collaborators 102 may include friends or family who follow the progress and contribute to the house hunting. User 101 and collaborators 102 may use the group chat module 115 to exchange opinions and comments about various properties on the list. Emails may not be rich enough for this particular application because copying emails to a large group of recipient who might have only a passing interest may be too intrusive and add unnecessary load to the email servers. Using a blog or Wiki may not be appropriate for this application either because they are too public and user unfriendly. The present system and method pulls together all the information on a page and allows convenient sharing among users.

Map module 112 shows the houses of which user 101 is seeking information. Map module 112 may collect and display the information using a variety of data parsers. Property information may be collected from the Internet or the URL links 113 on the page 100. Map module 112 may automatically scan the emails on the page 100 for the property addresses and displays them on a map. The present data parser has a comparative advantage over the traditional email “smart” logic because the page gives parser context to aggregate requested data across multiple emails. Emails may be logically grouped and sorted according to rules set by user 101 or collaborators 102.

According to one embodiment, the present system and method may be used in a business environment. The person who is the point of contact with customers often bears the brunt of being a switchboard and keeping the team members informed of changes and statuses. In one embodiment, the present system and method may be utilized in a catering business. The caterer is the point of contact with the customer, and user 101 coordinates team of assistants, baker, drivers and waiters (i.e., collectively referred to as collaborator 102). User 101 keeps track of a dozen catering jobs on a respective page. With the traditional email client and personal information manager (PIM) client, user 101 would have to instruct the collaborators 102, notify them the changes and updates, and check the status of each and every collaborators 102. On the contrary, the present system and methods allows user 101 to create and manage job pages that show task items marked with status indicator (done/started/in progress, etc.) and schedules of the team members. Emails from the client are automatically visible to the appropriate people working on a specific task. When the job is over, the caterer may leave notes or comments on the job page. For example, comments by the client that the soup was great but the chicken was not so good may be kept with the job page so that next time the client calls, user 101 has all that client data in one place.

In another embodiment, the present system and method is utilized for providing technical support for a product. A technical support page 100 is set up from a template to link emails 110, user feedback, frequently asked questions (FAQs), product specification, previously served case history history, and other information related to the product. The page may be shared with others on the team (i.e., collaborators 102) so that they can see the emails and notes related to that particular page. Discussion about specific issues may be entered on page 100. Task list 114 may be used to keep track of collaborators 102 who responded to the customer. A third party add-on developer might create a custom template page with custom modules that are designed for a specific type of applications.

According to one embodiment, user 101 organizes and views emails by project. User 101 specifies email criteria to automate the aggregation, organization, and management of the emails. Each project preferably has a start date and an end date, and the completed projects are archived to clean up user 101's work space.

According to one embodiment, emails and other communication mediums may be shared among a plurality of users 101 and collaborators 102. Because emails are shared through a page, the load of emails being exchanged, forwarded and copied is greatly reduced among the project team members working on a shared project. The project owner (i.e., user 101) may control the sharing privilege and permissions of the collaborators 102 to access and control content on the page 100.

According to one embodiment, page 100 integrates email client 110 and personal information manager (PIM) 120. Email client 110 provides the framework for the page 100, and PIM 120 provides additional information aggregated onto page 100.

According to one embodiment, a set of criteria is used to specify emails to include on the page 200. The template to create the page 200 may specify layout of the email client 201 along with other supporting modules. Collaborators 102 are invited and may be given different levels of permission to access and edit the contents of the page 200. The page 200 may contain advertisements and other interactive contents or links.

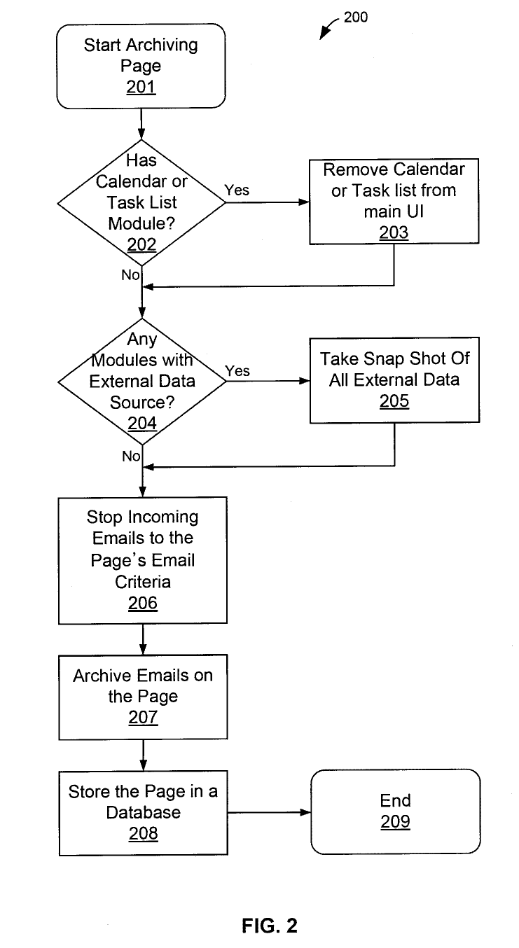

FIG. 2 illustrates an exemplary process for archiving a page, according to one embodiment. The page may be archived after completing a project or an event. When a page is to be archived, the page is checked if it includes any PIM module such as calendar 11 or task list 114 (202). If the page includes a PIM module, the PIM module and the PIM data associated with the PIM module are removed (203). In a preferred embodiment, the PIM modules included in the page are removed in a single action. The page is further checked if it includes an external module with associated data (204). If the page includes an external module, a snap shot of the external module data is taken (205) to save the data associated with the external module. Emails delegated to the page with specific email criteria are stopped (206), and all the existing emails as well as all PIM data on the page are archived (207 and 208). The archived page is stored in a database for future reference (209).

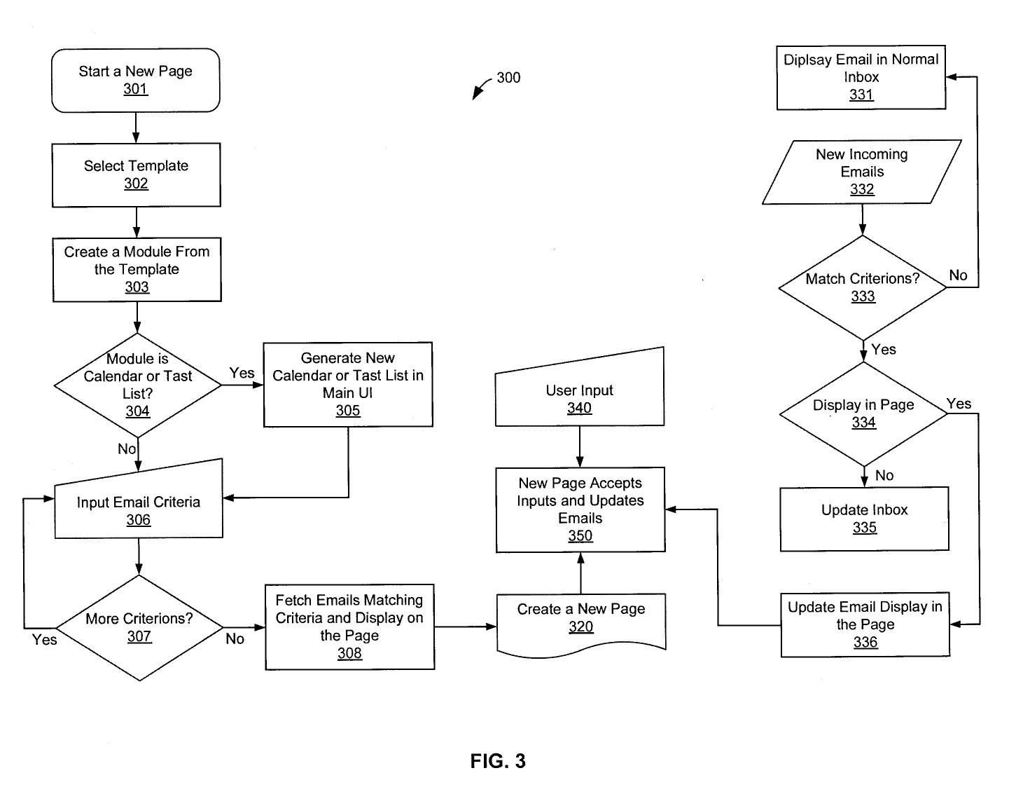

FIG. 3 illustrates an exemplary process for configuring a page, according to one embodiment. User 101 creates a new page (301) from a template (302). User 101 may select modules to create with the template or the template that user 101 selects may contain default modules in it (303). User interfaces for the modules are added to the page. User 101 also provides email criteria (306), and the emails matching the user-specified email criteria are fetched on to the page (308) to build a new page (320). The new page accepts user 101's inputs (340) and updates the user interface with incoming emails (350).

An incoming email (332) to the page is examined whether it matches the email criteria of the page (333). If no match is found, the email is bound to a normal inbox (i.e., inbox of a designated email client) of user 101, otherwise the email is displayed on the page (334) and the user 101's inbox is updated correspondingly (335). User 101 may configure to update both his/her normal inbox as well as the normal inbox linked to the page. Alternatively, user 101 may configure to update only the email module 110 of the page satisfying the email criteria in order to keep the normal inbox uncluttered. The emails arrived to the page are updated on the email module 110 of the page (336).

According to one embodiment, various selection rules and conditions are applied to select emails to link to a page. For example, emails received from a certain sender or emails received during a certain time period may be selected. Emails with a certain subject may all be selected. It is also possible that a combination of selection rules is applied to further narrow the range of email selection. In order to apply selection rules, emails in a repository (e.g., user's inbox) are searched, and the matching emails are selected. Emails may be hand-picked by users 101 to link to the page.

According to one embodiment, email selection process may be automated. An adaptive selection process may be learned over time. For example, a house hunting template originally contains emails from real estate agents who user 101 identified to link to the page. Over time, the template may learn and automatically add new agents to the page without manual selection. Adaptation rules may be pre-defined by user 101.

According to one embodiment, user 101 creates a page in various ways. A page may be created by selecting a template and specifying email criteria to fetch and redirect emails to the page. Alternatively, user 101 specifies the emails that will form the page from his/her email client and pick a template to include them.

User 101 may pick a template, otherwise a default template is used to create a page. Templates specify the types of supporting modules as well as the layout of the modules to be integrated to the page. User 101 provides the name and the title of the page. User 101 may optionally provide a description of the page and a list of collaborators 102 to invite. Email invitations are sent to the collaborators 112, from which collaborators 112 receives an instruction to create an account to the service and to access the page created by user 101.

The actual usage and layout of the page depend on the features and functionalities offered by the template chosen. For example, user 101 adds events to the calendar if the page contains a calendar module. User 101 communicates with collaborators 102 using a chat module 115.

According to one embodiment, users might pick a default template or create their own templates by arranging different modules in a layout that suits their particular needs. Templates and modules might be developed by third party developers using an API. Templates may be personalized with different image logos, color schemes, and background color or images. Some templates might include a built in criteria for selecting emails to include.

Edits made to the page are propagated to collaborators 102. Updated content on a client module of the page such as email 110, calendar 111, and task list 114 is propagated to the page shown to collaborators 102. In a similar fashion, the changes made on the client modules are immediately reflected in the page.

According to one embodiment, update notifications or indicators are used to allow user 101 or collaborators 102 to easily identify and find updated content. A record of changes made to the page may be stored in an archive and delivered with or at the request of update notifications or indicators. The log contains details of the changes, a timestamp, and the identification of the person who made the changes. Using the records of changes, the page can be rolled back to a previous state by undoing the changes made since the previous state.

The emails gathered in a page may show up only on the page or are also available in the inbox of user 101's email client. User 101 may switch between the page view and the more traditional inbox view. User 101 may opt for the flexibility of viewing emails in both ways over the benefits of managing emails through the page.

According to one embodiment, a page may be shared with anyone with an email address. User 101 invites collaborators 102 by entering their email addresses to a collaborator list. Invitations are emailed to the addressees with an optional message about the page from user 101. The invited collaborators 102 are classified into two types: registered users and non-registered users. Registered users have created accounts and have access to a Web service that the present system and method may provide. Registered users can create a page to invite other registered users and can invite non-registered users to join the service.

For registered users, the page shows up in their account along other pages on which they are listed including the ones that they have created (thus have the ownership). The pages show the owner and the listed collaborators. Upon accepting the invitation, the registered user can access and contribute to the page.

For non-registered users, the invitation email may contain a URL link from which the user receives an instruction to create an account or access the page as a non-registered user. When multiple invitations are sent to a user, the user can access all the invited pages from that unique URL. For example, the user receives ten separate URL links, and the user can simply bookmark any one of the ten URL links to access the ten pages linked thereto.

According to one embodiment, non-registered users may be given the same level of functionality as other registered collaborators. However, non-registered users may not be able to create their own pages. The owner of a page may remove other collaborators. When the page is removed, the page is directly removed from the registered collaborator's account as well. For non-registered users, the old unique URL link is marked as obsolete. If there are other non-registered collaborators left associated with a removed page, a new invitation including a new URL link is sent out to the collaborators so they can continue to access the page.

According to one embodiment, protection from unwanted spam invitations is provided by filtering invitations using a black or white list. Invitations from a spammer listed in the black list are blocked before reaching to the invitees.

According to one embodiment, special rules are applied for handling shared emails. For example, the owner of a page may prohibit collaborators to reply to emails. The owner might set the email module for viewing only. In another example, the owner may require collaborators to exhibit their identity when replying to emails. Other situation may arise where the owner grants full delegation permission to a collaborator and allows him/her to reply to emails using the owner's identity. The owner may set different levels of permission for each collaborator. The content on the page may be set for viewing only, viewing and editing, or viewing-editing-and-managing depending on the permission level of the collaborator. More complex and finer grain control may be applied on a module basis or a permission basis.

According to one embodiment, a page may represent a project or an event with a start and end date. The end date is marked when the project is completed or the owner of the page decides to end the page. An archive of the page is created by including the associated emails and all the other content posted or linked to the page. The single action of a page archiving cleans up the page and the associated content, which is impossible with a traditional email client. The archive keeps all the relevant information together. A user who has a permission to access may search needed information from the archived page.

According to one embodiment, emails designated to an archived page may no longer be forwarded to the page. For example, if a tag “craigslist” is associated to an archived page, it does not show new emails tagged “craigslist” when reviewed the next month. This allows the same simple criteria to be used when the same user sells something else on craigslist next month. The previously archived page may be set frozen and would not be effected by new craigslist emails. Other features are provided for searching, grouping, tagging, starring, rating, and archiving emails and other content on an active or an archived page.

Templates provide useful features depending on different types of projects. The power of templates comes from the grouping of various modules. Among a large number of templates available, users may not find all of them useful, just like other applications, plug-ins or add-ons. Users may pick favorite templates and include them in his/her personal list for easy access to them. A mechanism to help users to search, find, browse, and get recommendations of templates may also be provided.

Modules are the building blocks for constructing a page. According to one embodiment, there are 4 general types of modules. First type includes the modules that are tightly integrated with the rest of the application. Examples of the first type modules include email 110, calendar 111, and task list module 114. Multiple views of the data from these modules may be provided to the user.

Second type includes the modules that are integrated with external data sources. An examples is a URL link module 113 integrated with an online book marking site. Other examples include chat modules 115 that are connected to an instant messaging service, or VoIP modules for voice chats with other collaborators.

Third type includes the modules that parse the contents of emails to create a specialized view of the email. For example, in the real estate search template, a map module 112 scans the included emails for property addresses and display them on the map. This type of data parser has a huge advantage over the traditional email “smart” logic because the page collects emails from various resources and examine them as a whole. Some traditional email clients scan the contents of emails and find valid addresses therein. However, mapping each individual email is quite limited when compared to mapping the addresses collected from multiple emails from real estate agents. The page may logically group emails by the sender, by the area or any other grouping criteria. Another example of logical grouping is a holiday present shopping page. User gathers the online shopping emails, and a package tracker module scans the emails with tracking numbers and display the statuses of all the holiday deliveries. The shopping page may include various online accounts and passwords for enabling easy shopping at various online venders and tracking payment methods and history.

The last type includes standalone modules such as a note module or a menu plan module. The hosting of other widgets on templates may be accomplished by using public APIs like Google's Open Social.

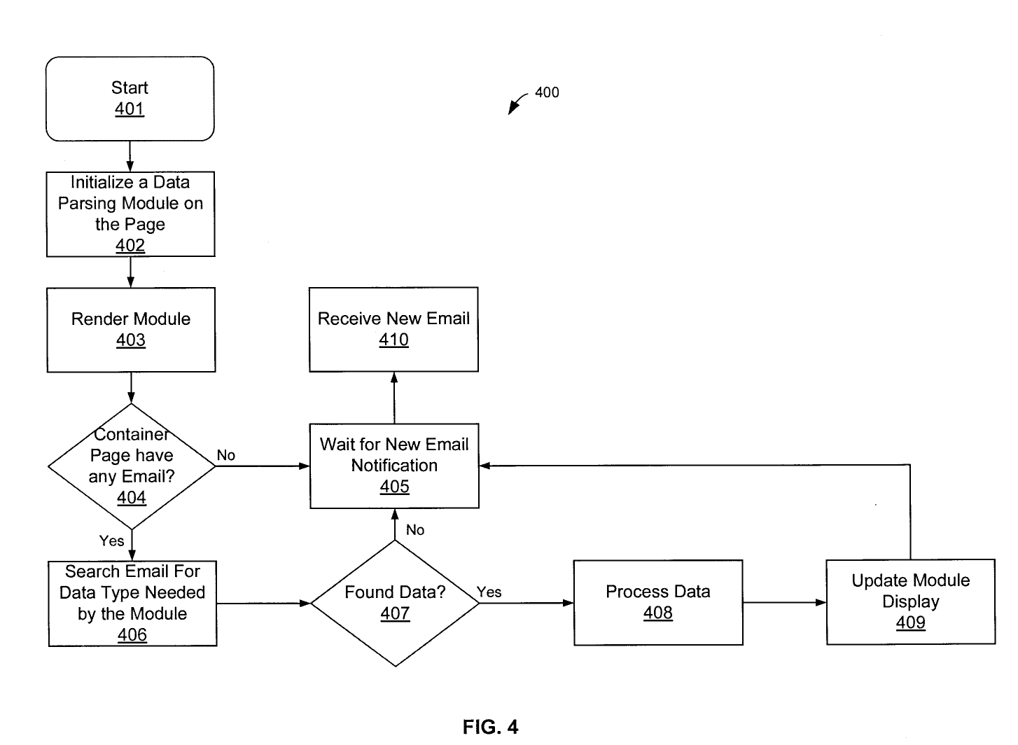

FIG. 4 illustrates an exemplary process for parsing email data, according to one embodiment. A data parsing module is selected and initialized (402) and rendered (403) on page 100. If a container page includes any emails, emails are searched for data type needed by the module (406). If the contain page does not have any emails (404), the container page waits for new email notification (405) for processing the incoming emails. The incoming emails are searched for data type needed by the parsing module (406). If matching data is found (407), the data is processed (408) and the module is updated correspondingly (409). New emails are received (410) and processed by the data parsing module. Email data parser modules leverage the context of the template to present a specialized and customized presentation of the parsed data to users. Although the present example illustrates email data parse modules, other data on the page may be parsed in a similar fashion without deviating from the scope of the present subject matter.

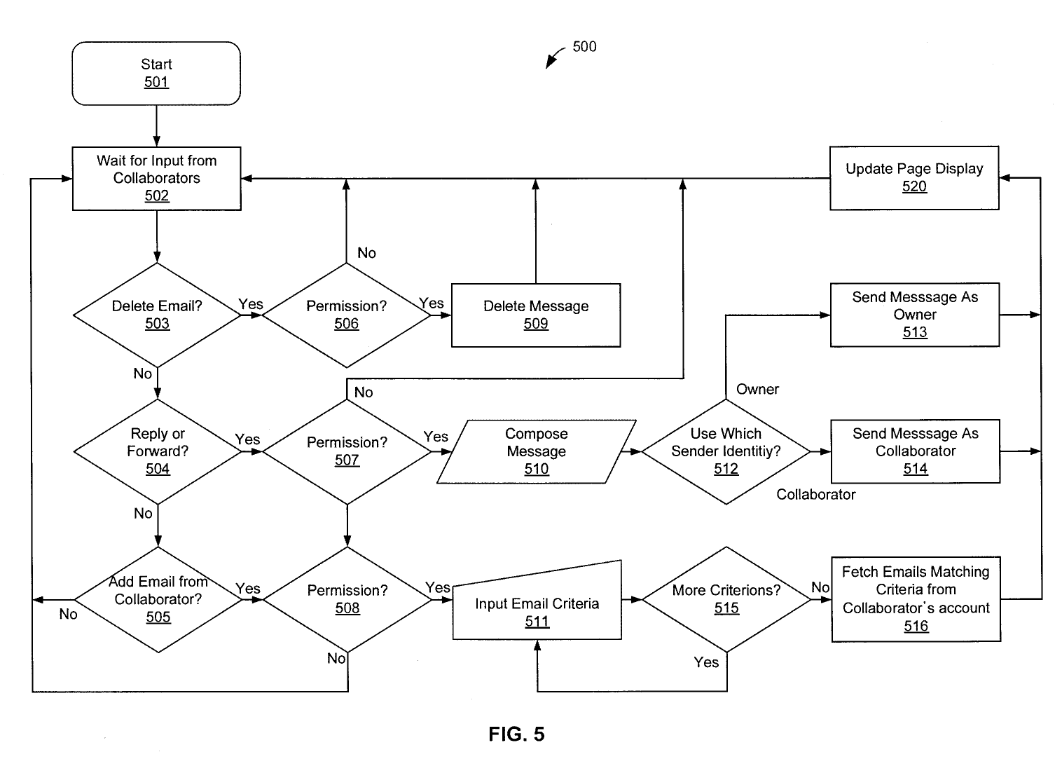

FIG. 5 illustrates an exemplary process for shared email collaboration on a page, according to one embodiment. The page is shared among the owner 101 and one or more collaborators 102. Collaborator 102 inputs a request for a change on the page (502). If collaborator 102 tries to delete an email and has an appropriate permission to delete emails, the email is deleted (509) and the page is updated (510). If collaborator 102 replies or forwards an email (504) and has an appropriate permission (507), a message is composed (510). Collaborator 102 is asked to select a sender's identity (512). If owner 101's identity is selected, the message is sent as if it were composed by owner 101 (513), otherwise, the message is sent from the collaborator 102 (514). If emails from collaborator 102 is to be added (505), and such addition is allowed (508), email criteria is applied to the emails whether to include them on the page (511). The emails with matching email criteria are fetched from collaborator 102's email account (516), and the page is updated correspondingly (520).

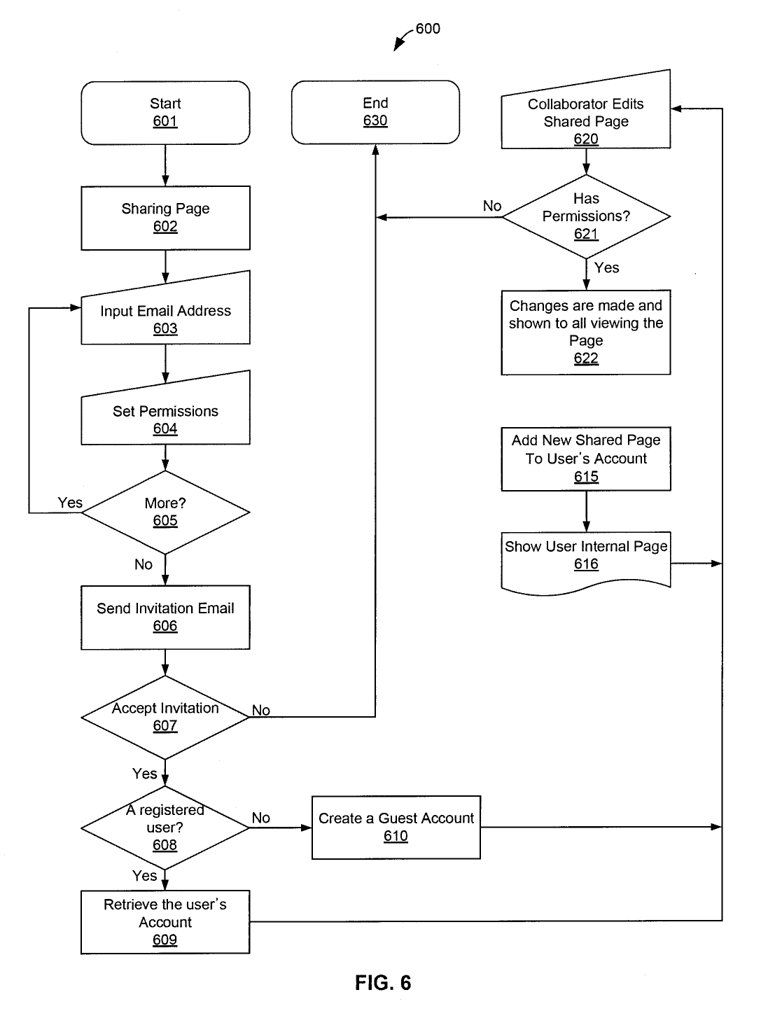

FIG. 6 illustrates an exemplary process for sharing a page with a collaborator, according to one embodiment. When a page is configured for sharing (602), email addresses are entered to recover proper emails matching email criteria (603). Permissions to delete, reply, or forward emails per each collaborator 102 is set (604). For each invited collaborator 102, an invitation email is sent (606). If the collaborator 102 accepts the invitation (607), it is checked whether the collaborator 102 is a registered user to the present system (608). If the collaborator 102 is not a registered user, a guest account is created and the collaborator 102 provides information to generate an identity with the guest account (610). If the collaborator 102 is a registered user to the system, the user's account is retrieved and linked to the page (609). The new shared page is added to the collaborator 102's account (615), and the new page is displayed on the collaborator 102's internal page (616). Depending on the permission given by the owner of the page, collaborator 102 may edit the shared page (620). According to the permission to the collaborator (621), changes may be made to the page and the pages to other collaborators to the page are updated (622).

Every email client application requires the user to enter some basic email account information in order to fetch their emails. These email clients include MS Outlook, Apple Mail, Eudora, or Thunderbird. Users need to enter their email provider's incoming and outgoing server address, port number, encryption setting, login ID and password. Similarly, Webmail clients such as Gmail, hotmail, and Yahoo mail may access user's other email account, but also requires the user to enter that account configuration information during the configuration. These configuration process is for users.

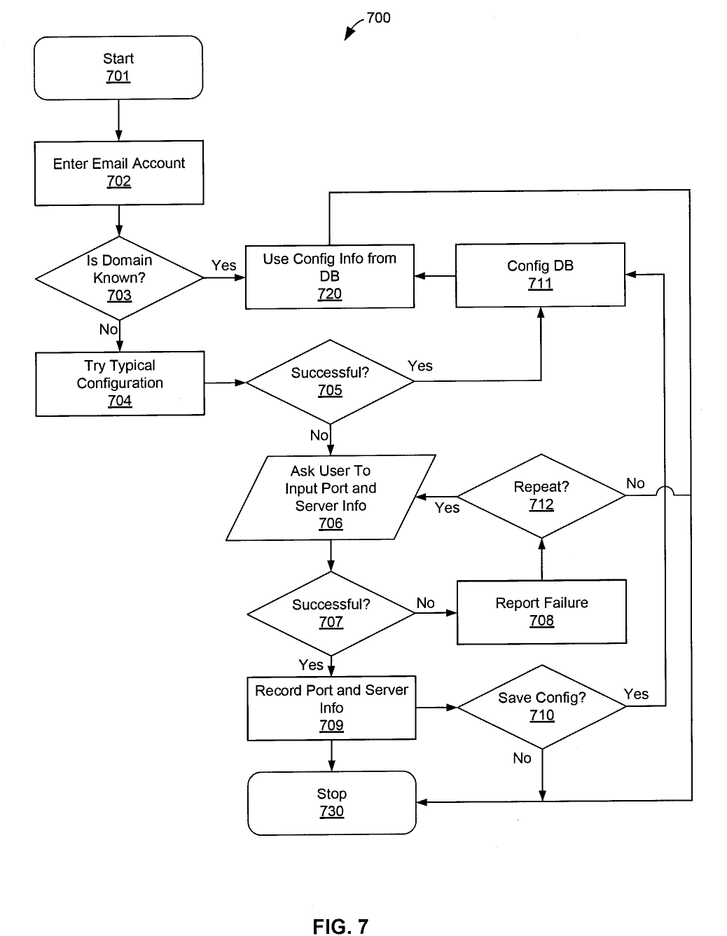

FIG. 7 illustrates an exemplary process for setting up an email account linked to a page, according to one embodiment. User 101 enters an email account (702) with basic account information such as email account ID and password. Using the entered email address, the domain is checked if there is a matching configuration data on the database (703). If there is a matching configuration data, the matching configuration data is used to complete the email account set-up (720). If there is no matching configuration data on the database, typical email configuration data are tried (704). If the typical email configuration data works, the results are saved to the database (711) for future referencing to the domain. If the typical email configuration data fails, user 101 is asked to manually enter the port and server information (706). Each time it fails, user 101 is informed of the failure (708) and asked whether to continue or stop (712). If the user-provided port and server information passes (709), the working data is recorded (709) and saved to the database (711) for future reference to the domain.

According to one embodiment, the present method and system provides a smart email account configuration process. For most users, email configuration process is overly complex, often unnecessary and confusing, and error prone. Because the configuration information by most email service providers is the same for all their users, the email configuration process may be automated with minimal user inputs. The configuration information for email service providers such as port number, server names, etc. is stored in a database to facilitate the email configuration process. Users may only need to enter their email address and password to complete the account configuration process in most cases.

The user-provided email address is looked up in the database to find appropriate configuration information for the account. If there is a matching entry, the user's account is tried and the user is notified of the success of failure of the trial. If there is no configuration data entry for the account, some common configuration settings may be tried before asking the user for more information. If connection fails, user is prompted with a full configuration dialog where the user enters the detailed configuration data. If the user-provided configuration data is a valid one, the configuration data is saved into the database for the next user who as an account with the same service provider.

An apparatus and method for customized emails and data management have been described. It is understood that the embodiments described herein are for the purpose of elucidation and should not be considered limiting the subject matter of the present patent. Various modifications, uses, substitutions, combinations, improvements, methods of productions without departing from the scope or spirit of the present invention would be evident to a person skilled in the art.

We claim:

1. A computer-implemented method, comprising:
creating a collaborative page containing an email module, the email module being configured to access one or more email accounts;
selecting emails from the one or more email accounts using an email selection criterion;
parsing data on the selected emails based on a parsing rule;
displaying the emails and the parsed data on the collaborative page; and
updating the collaborative page as the emails and the parsed data update.

2. The computer-implemented method of claim 1 further comprising sharing the collaborative page with one or more collaborators, wherein the one or more collaborators view and edit the collaborative page based on an access level to the collaborative page.

3. The computer-implemented method of claim 2 further comprising inviting the one or more collaborators to the collaborative page by emails.

4. The computer-implemented method of claim 1 further comprising archiving the collaborative page in a database.

5. The computer-implemented method of claim 1, wherein the collaborative page is customized for selling an item.

6. The computer-implemented method of claim 1, wherein the collaborative page is customized for a house hunting project.

7. The computer-implemented method of claim 1, wherein the collaborative page is customized for coordinating a catering event.

8. The computer-implemented method of claim 1, wherein the collaborative page is customized for coordinating technical support for a product.

9. The computer-implemented method of claim 1, wherein the collaborative page is customized for online shopping to keep track of orders, order status, payment method, and payment history.

10. The computer-implemented method of claim 1, wherein the collaborative page includes one or more of a calendar module, a map module, URL links, task list module, and a chat module.

11. A computer-readable medium having stored thereon a plurality of instructions, said plurality of instructions when executed by a computer, cause said computer to perform:
creating a collaborative page containing an email module, the email module being configured to access one or more email accounts;
selecting emails from the one or more email accounts using an email selection criterion;
parsing data on the selected emails based on a parsing rule;
displaying the emails and the parsed data on the collaborative page; and
updating the collaborative page as the emails and the parsed data update.

12. The computer-readable medium of claim 11 having stored thereon a plurality of instructions, said plurality of instructions when executed by a computer, cause said computer to further perform:
sharing the collaborative page with one or more collaborators, wherein the one or more collaborators view and edit the collaborative page based on an access level to the collaborative page.

13. The computer-readable medium of claim 12 having stored thereon a plurality of instructions, said plurality of instructions when executed by a computer, cause said computer to further perform:
inviting the one or more collaborators to the collaborative page by emails.

14. The computer-readable medium of claim 12 having stored thereon a plurality of instructions, said plurality of instructions when executed by a computer, cause said computer to further perform:
archiving the collaborative page in a database.

15. The computer-readable medium of claim 11, wherein the collaborative page is customized for selling an item.

16. The computer-readable medium of claim 11, wherein the collaborative page is customized for a house hunting project.

17. The computer-readable medium of claim 11, wherein the collaborative page is customized for coordinating a catering event.

18. The computer-readable medium of claim 11, wherein the collaborative page is customized for coordinating technical support for a product.

19. The computer-readable medium of claim 11, wherein the collaborative page is customized for online shopping to keep track of orders, order status, payment method, and payment history.

20. The computer-readable medium of claim 11, wherein the collaborative page includes one or more of a calendar module, a map module, URL links, task list module, and a chat module.
